(19) United States
(12) Patent Application Publication
(10) Pub. No.: US 2019/0101002 A1
(43) Pub. Date: Apr. 4, 2019

(54) BLADE OR VANE FOR A GAS TURBINE ENGINE

(71) Applicant: ROLLS-ROYCE PLC, London (GB)

(72) Inventors: Roger S. DUFFIN, Derby (GB); Gabriel GONZALEZ-GUTIERREZ, Derby (GB)

(73) Assignee: ROLLS-ROYCE PLC, London (GB)

(21) Appl. No.: 16/128,671

(22) Filed: Sep. 12, 2018

(30) Foreign Application Priority Data
Oct. 4, 2017 (GB) 1716178.7

(51) Int. Cl. F01D 5/14; F01D 5/16; F04D 29/38; F04D 29/66; F01D 9/04

(52) U.S. Cl. CPC F01D 5/141; F05D 2230/80; F04D 29/384; F04D 29/667; F01D 9/041; F05D 2220/32; F05D 2220/36; F05D 2230/10; F05D 2230/90; F05D 2240/303; F05D 2240/31; F05D 2260/96; F05D 2240/121; F05D 2250/294; F05D 2250/183; F01D 5/16

(57) ABSTRACT

A blade or vane for a gas turbine engine comprising a pressure surface and a suction surface. The pressure surface or the suction surface comprises a roughness zone which is configured to provide greater flow resistance in a direction along the blade or vane than in a direction across the blade or vane.

### CROSS-REFERENCE TO RELATED APPLICATIONS

This specification is based upon and claims the benefit of priority from UK Patent Application Number 1716178.7 filed on 4 Oct. 2017, the entire contents of which are incorporated herein by reference.

### BACKGROUND

### 1. Field of the Disclosure

The present disclosure concerns blades or vanes for a gas turbine engine and, in particular but not exclusively, to flutter control of blades and vanes for gas turbine engines.

### 2. Description of the Related Art

Many gas turbine engines comprise a number of rotary parts having fan-like blades, such as main fan blades, compressor blades or vanes, and turbine blades or vanes. The main fan blades produce more than 80% of the engine thrust and therefore the aerofoil design of each fan blade is an important contributor of the overall gas turbine efficiency.

During engine operations, flutter is one of the main problems that fan blades face and many studies have taken place in order to understand this phenomenon. Fan flutter is an aero-elastic instability occurring generally as a non-integral order vibration. If left unchecked, flutter might lead to engine damage or operational restrictions.

Accordingly, it is desirable to provide improvements relating to reducing and inhibiting fan blade flutter.

### SUMMARY

According to a first aspect there is provided a blade or vane for a gas turbine engine comprising a pressure surface and a suction surface, wherein at least one of the pressure surface and the suction surface comprises a roughness zone which is configured to provide greater flow resistance in a direction along the blade or vane than in a direction across the blade or vane.

For brevity, the following description will refer to a blade only, but it should be understood that the features of the blades described could equally be applied to a vane for a gas turbine engine.

The roughness zone may inhibit three dimensional boundary layers long the blade during its use. Three-dimensional boundary layers increase likelihood of flutter, so the reduction of flow separation may provide a reduction in the likelihood of flutter. It may also be said that the roughness zone exhibits greater roughness in a direction along the blade than in a direction across the blade.

The blade may comprise a root and a tip. In use the root is arranged at a radially inner location, such as in a fan disk, and the tip is arranged at a radially outer location. It should be understood that when referring to a direction “along” the blade, this generally refers to a direction extending from the root to the tip of the blade, which may be referred to as a spanwise direction. A direction “along” the blade may also be referred to as a “radial direction”.

The blade may also have a leading edge and a trailing edge. In use the leading edge is arranged to generally face axially forward in the engine and the trailing edge is arranged to generally face axially rearward in the engine. It should be understood that when referring to a direction “across” the blade, this generally refers to a direction extending from the leading edge to the trailing edge of the blade at substantially the same distance along the blade. The leading edge is generally the first part of the blade impinged by flow through the engine, so flow across the blade will generally pass across the blade from the leading edge to the trailing edge. A direction “across” the blade may also be referred to as a generally chordwise direction, or in some arrangements a generally “axial direction”.

The suction surface of the blade generally extends between the leading and trailing edges on a first side of blade, and the pressure surface of the blade generally extends between the leading and trailing edges on a second opposing side of blade. In a cross section along the blade, the suction surface may be generally convex and the pressure surface may be generally concave.

The blade may be of a rotary component of a gas turbine engine, such as a bladed disk with integrally formed blades, or a conventional disk with attachable blades. The blade may comprise a root portion for connecting the blade to a disk.

The roughness zone may generally be a defined area of the blade within which the directional roughness effect is provided.

The roughness zone may be elongate and may extend generally along the blade. For completeness, it should be understood that “elongate” generally refers to one dimension of the zone being substantially larger than the other dimension.

Accordingly, when it is stated that the roughness zone may extend along the blade, the longer dimension of the roughness zone may extend generally along blade.

The roughness zone may comprise a plurality of elongate roughened areas which are spaced apart in a direction along the blade and extend generally in a flow direction across the blade. For completeness, it should be understood that “elongate” generally refers to one dimension of the roughened area being substantially larger than the other dimension. The elongate areas may or may not be continuously rough across the blade. For example, the roughened area could be continuous along its length, or could be in the formed of a ‘dashed’ strip of roughness extending across the blade. In an example, the roughened areas may extend between 0.2%-10% of the fan tip diameter along the blade, and approximately 1%-10% of the fan tip diameter across the blade. In some cases, the roughened areas may extend in a direction substantially perpendicular to the direction of extent of the roughness zone.

By “roughened”, it should be understood that the surface roughness is substantially greater than a remainder of the blade surface, and in particular the suction surface. For illustrative and non-limiting purposes, the roughened areas might have a surface roughness of greater than 2.0 μm Ra (where Ra is the arithmetic average of the roughness profile), between 10 μm-20 μm or even up to around 200-500 μm Ra for large fan blades. The remainder of the suction surface might have a surface roughness of between 0.2 μm Ra and 1.6 μm Ra. In some examples, the roughness of the roughened areas will be 10-100 times higher than the remainder of the blade, or even up to around 1000 times higher if the remainder of the blade is super-polished. It should be understood that the roughened areas are designed to induce turbulent flow over their surface.

The roughness zone may comprise a plurality of roughness areas which are each substantially aligned to the flow streamlines across the blade at their particular radial location along the blade. Therefore, a single roughness zone may comprise a plurality of differently extending roughness areas, which may or may not be parallel to one another.

The roughened areas may be substantially continuous along their length.

A plurality of smooth areas may be formed between the roughened areas on the suction surface. The smooth areas may generally extend in the flow direction across the blade.

The smooth areas may be polished areas of the suction surface. The roughened areas may be unpolished areas of the suction surface. The roughened areas may be areas which are left as-cast, while the smooth areas may be polished.

The roughened areas may be areas which have been machined or processed to provide increased roughness compared to a remainder of the suction surface, which may include the smooth areas. The roughened area could comprise micro holes, which could be formed perpendicular to the suction surface, or at an angle thereto in the manner to form a scale-like finish. In other non-exhaustive examples, the roughened areas could be formed with ball-peening, micro grooves, grinding, sand or metal blasting, brushing, or chemical etching, such as acid etching.

The roughened areas may comprise a roughened coating or roughened element which is applied to the blade. The coating may be a powder, gel, or liquid coating which is applied to the blade to increase surface roughness, or could be a separate roughened layer which it affixed to the blade, for example by gluing or welding.

The roughness zone may comprises a plurality of grooves are spaced apart in a direction along the blade and extend generally in a flow direction across the blade. The grooves may be step-shaped, trapezoidal, triangular, dovetail, or saw tooth in cross-section. For completeness, it should be understood that “elongate” generally refers to one dimension of the groove being substantially larger than the other dimension or dimensions. The out-of-plane height difference of the grooves may be around 0.2 mm to 0.5 mm. Accordingly, when it is stated that the grooves may extend along the blade, the longer dimension of the grooves may extend generally along blade. In some cases, the grooves may extend in a direction substantially perpendicular to the direction of extent of the roughness zone.

A plurality of raised areas may be formed between the grooves. The raised areas generally extend in the flow direction across the blade. It should be understood that the raised areas are raised with respect to the grooves. For example, the grooves may be formed by machining out grooves in the suction surface, leaving the un-machined strips between the newly-formed grooved as the raised areas, when though those areas are not actually raised with respect to the remainder of the suction surface.

In some examples, roughened areas may be formed on the raised areas between the grooves. The entire surface of the raised area may be roughened such that the raised area is a raised roughened area. Side walls of the raised areas/grooves may be smooth or roughened.

The roughened areas and/or the grooves may be substantially aligned with the flow streamlines across the blade in use. In other examples the roughened areas and/or the grooves could be misaligned from the flow streamlines by a maximum angle, for example by 20°, 15°, 10°, or 5°.

The roughened areas and/or the grooves may be substantially linear and may be arranged in parallel. The roughened areas and/or grooves may be arranged in a ladder-like formation along the blade.

The roughened areas and/or grooves may be substantially aligned with flow streamlines across the blade

The roughened areas and/or the grooves may be arcuate across the suction surface of the blade.

The roughened areas and/or the grooves may be substantially zig-zag shaped. It should be understood that although any give part of a zig-zag-shaped area or groove may not be extending in a direction across the blade, each area or groove as a whole may generally extend in a direction across the blade.

The roughness zone may be formed proximate a leading edge of the blade. In particular, the roughness zone may be formed within the foremost 10% of the chord of the blade.

The roughness zone may be formed proximate or extending across a midspan of the blade from the root to the tip. In particular, the roughness zone may extend from approximately 20% of the blade height from a root of the blade to approximately 75% of the blade height from the root of the blade.

The roughness zone may be configured to resist or impede radial flow migration along the blade in use.

The roughness zone may be a flutter control feature.

The blade may be a fan blade for a fan of a gas turbine engine.

For blades in particular, the roughness zone may be provided on the suction surface.

For vanes in particular, the roughness zone may be provided on the pressure surface.

According to a second aspect, there is provided a fan or bladed disk for a gas turbine engine comprising one or more blades or vanes according to the first aspect.

According to a third aspect, there is provided a gas turbine engine comprising a fan or bladed disk according to the second aspect.

According to a fourth aspect, there is provided a method of manufacturing a blade or vane for a gas turbine engine according to the first aspect.

According to a fifth aspect, there is provided a method of modifying a blade or vane for a gas turbine engine comprising forming a roughness zone on a suction surface or pressure surface of the blade or vane, the roughness zone being configured to provide greater flow resistance in a direction along the blade or vane than in a direction across the blade or vane. The roughness zone may be according to the roughness zone of the first aspect.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a schematic plan view of a blade;

FIG. 3A is a schematic plan view of an alternative blade;

FIG. 3B is a schematic plan view of a further alternative blade;

FIG. 3C is a schematic plan view of a further alternative blade;

FIG. 3D is a schematic plan view of a further alternative blade;

FIG. 4A is a schematic sectional view of a first configuration of the blade of FIG. 2;

FIG. 4B is a schematic sectional view of a second configuration of the blade of FIG. 2;

FIG. 4C is a schematic sectional view of a third configuration of the blade of FIG. 2; and

FIG. 4D is a schematic sectional view of a fourth configuration of the blade of FIG. 2.

### DETAILED DESCRIPTION OF THE DISCLOSURE

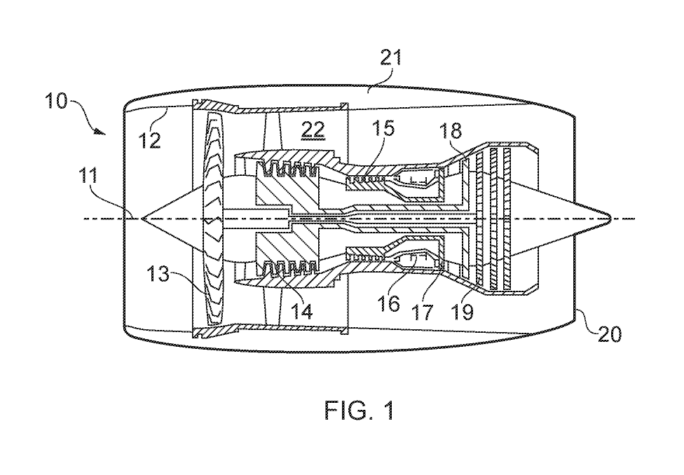

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The fan 13, the compressors 14, 15, and the turbines 17, 18, 19 each comprise at least one rotatable disk having a plurality of radially-extending blades. In some cases, the disk and the blades may be integrally formed and in other cases, the blades may be formed separately and then attached to the disk, for example with a fir-tree root arrangement.

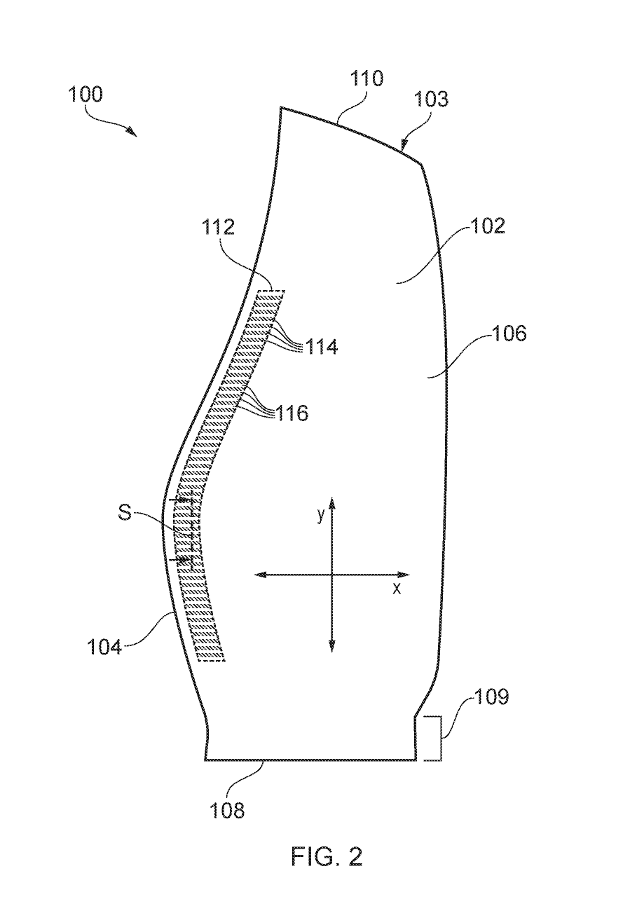

FIG. 2 shows a schematic view of one such blade. In this case, the blade 100 is a blade for the main propulsive fan 13 and is formed separately to the fan disk (not shown). However, it should be understood that the blade 100 could equally be a compressor or turbine blade and/or could equally be formed integrally with a disk. It should be understood that the present disclosure could equally be applied to vanes, such as stator vanes.

The blade 100 is shown in FIG. 2 with the suction surface 102 facing the observer. The opposite face 103 of the blade 100 is the pressure face 103. The blade 100 is aerofoil-shaped in a cross section viewed along the blade in the radial direction. Accordingly, in use, the air flow past the blade 100 is such that the pressure over the pressure face 103 than over the suction face 102. The blade 100 could be solid or hollow.

The blade 100 comprises a leading edge 104 and a trailing edge 106. The leading edge 104 of the blade 100 is the axially foremost part of the blade 100 when it is arranged in the engine 10. The leading edge 104 will separate the air flow over the blade 100 between the suction surface 102 and the pressure surface 103 in use. Conversely, the trailing edge 106 of the blade 100 is the axially rearmost part of the blade 100 when it is arranged in the engine 10. The separated airflows over the suction 102 and pressure 103 surfaces re-join one another proximate the trailing edge 106 in use.

The blade 100 extends from a root 108 to a tip 110. A root 109 is provided proximate the root 108 for attaching the blade 100 to a fan disk (not shown). For example, the root portion 109 may be a fir-tree root. In use, the blade 100 is attached to a fan disk with the root portion 109 securing the blade to the disk, and with the blade 100 extending radially outwards from the disk with the tip 110 radially outermost. A plurality of blades 100 are provided about the circumference of the disk to form a complete ring of circumferentially spaced blades 100 on the disk.

It can be seen that the suction surface 102 generally extends across an entire face of the blade 100 and is bordered the leading and trailing edges 104, 106, and the root 108 and tip 110. It will be understood that the suction surface likewise extends over the entire opposing face of the blade 100.

In order to define features of the blade 100 more easily, features which extend or align predominantly or generally with a direction x between the leading and trailing edges 104,106 will be described as extending “across” the blade 100 or in the “axial” direction (relative to the engine 10 when the blade 100 is installed therein). Likewise, features which extend or align predominantly with a direction y between the root 108 and tip 110 will be described as extending “along” the blade 100 or in the “radial” direction (relative to the engine 10 when the blade 100 is installed therein).

The blade 100 further comprises a roughness zone 112 formed on the suction surface 102. The roughness zone 112 is an elongate area of the blade which extends generally along the blade 100. The roughness zone 112 is formed proximate to the leading edge 104 of the blade 100 and generally conforms to the shape and contours of the leading edge 104 along its length. In this example, the roughness zone 112 may extend across the blade from around 0%-30% of the blade chord. The roughness zone 112 extends from around 20% of the length along the blade 100 measured from the root 108 to around 80% of the length along the blade 100 measured from the root 108 (i.e. from around 25% to around 80% of the length along the blade measured from the tip 110). Generally, the roughness zone 112 spans along the blade 100 across a midspan of the blade 100 The roughness zone 112 does not extend completely to the root 108 or tip 110 of the blade, but in other examples, it may extend a different amount along the blade.

In the perpendicular direction across the blade 100, the roughness zone 112 is substantially shorter than its length along the blade 100. In this example, the roughness zone 112 only extends across the foremost 10% of the chord length across the blade 100. In other examples, the roughness zone may be wider across the blade 100.

Generally, the length of the roughness zone 112 along the blade 100 will be substantially longer than its width across the blade 100. Accordingly, the zone 112 may be described as elongate. In some examples, the roughness zone may be at least an order of magnitude longer than it is wide.

The roughness zone 112 is configured to generate streamwise vortices which could be counter- or co-rotating in pairs. Accordingly, the roughness zone 112 inhibits boundary layer separation, with or without downstream reattachment, along the blade 100 during its use. Flow separation may be a principal contribution factor to flutter in fan blades, so the reduction of flow separation may provide a reduction in flutter.

It may also be said that the roughness zone exhibits greater roughness in a direction along the blade than in a direction across the blade.

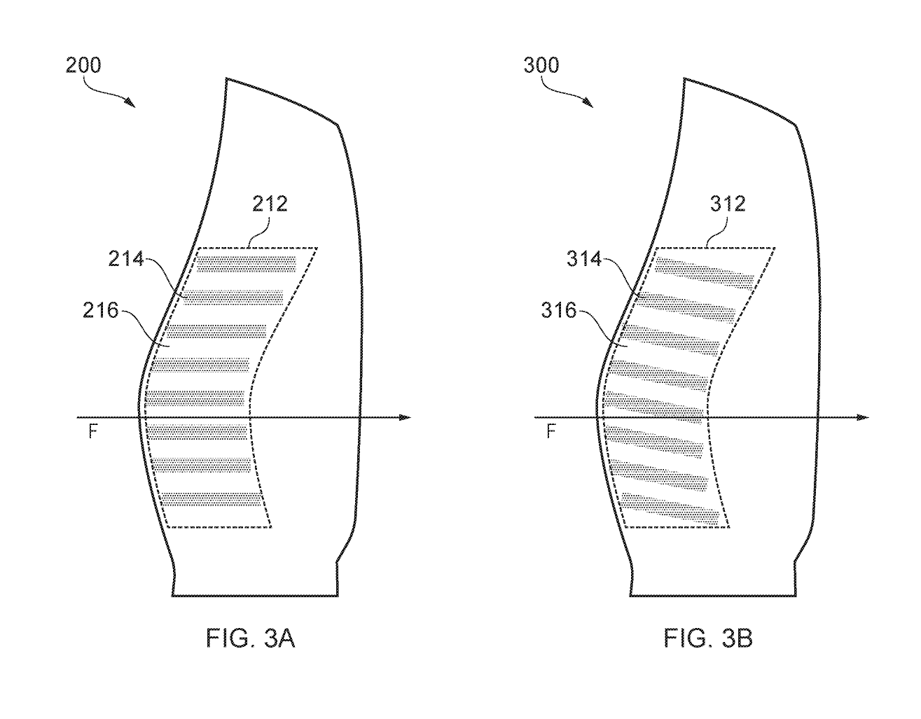

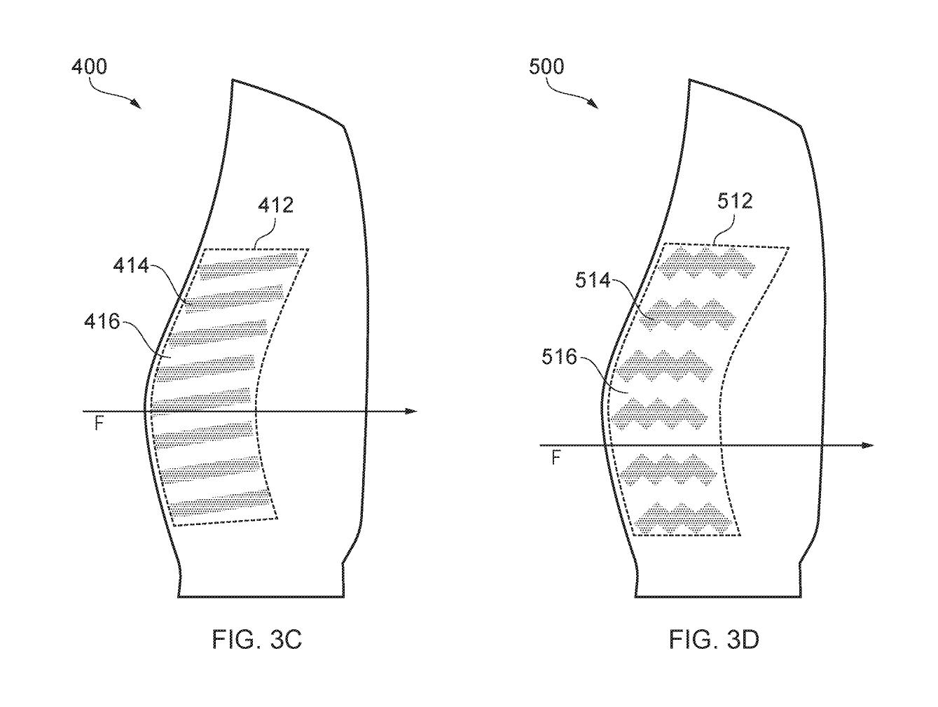

In this example, the roughness zone 112 comprises a plurality of roughened areas 114 which are spaced apart along the blade 100 in a ladder-like formation. Formed between the roughened areas 114 are a plurality of smooth areas 116. The roughened areas 114 have a surface roughness which is substantially more than the surface roughness of the smooth areas 116. As the areas are substantially longer than their width, they may also be referred to as “strips”. The exact form of the roughness zone and some potential variations thereof will be discussed further in relation to FIGS. 3A-D and 4A-D.

In this example, the roughened areas 114 and the smooth areas 116 generally extend in a direction across the blade 100 (i.e. across the width of the roughness zone 112).

In use, the flow streamlines over the suction surface 102 are generally across the blade 100. Accordingly, air flow across the blade 100 can pass more easily across the alternating roughened and smooth areas 114,116 of the roughness zone 112 which extend in this direction. Air flow may be guided relatively easily along the smooth areas 116. However, air flow over the roughness zone 112 in the direction along the blade 100 is more difficult, as the airflow must navigate over a large number of alternating surface roughnesses.

Turning now to FIGS. 3A-3D, a number of alternative arrangements of the roughness zone are schematically illustrated. In these examples, the size of the roughness zone and the roughened and smooth areas are greatly exaggerated for illustrative purposes and to improve understanding. Generally, the size and shape of the roughness zone will typically be closer to that shown in FIG. 2. In each of these Figures, a representative air flow direction F over the suction surface is shown. It should be understood that the exact air flow direction over the suction surface may vary across the surface and may not be exactly in the direction F, but the direction F is shown to illustrate the relative orientation of features of the blades to a notional air flow direction over them. In some examples, direction F may be substantially parallel to direction x across the blade. However, it should be understood that directions F and X may instead be misaligned by some degree and that, in such examples, it may still be described that direction F is across the blade.

FIG. 3A shows a blade 200 having a roughness zone 212. In this example, the roughened areas 214 and the smooth areas 216 are substantially parallel to the air flow direction F across the suction surface. Such an arrangement may provide particularly low resistance to flow across the blade 200.

FIG. 3B shows an alternative blade 300 having a roughness zone 312. In this example, the roughened areas 314 and the smooth areas 316 are formed at an angle to the air flow direction F. This angle could be up to around 20°, 15°, 10°, or 5°. In this example, the areas 314, 316 extend slightly radially inward in addition to across the blade 300. Accordingly, it should be understood that, even if they are slightly mis-aligned with the direction across the blade or the air flow direction F, the areas 314, 316 may still be described as extending across the blade if this is their main direction of extent. Inwardly directed roughness areas may be advantageous if the roughness zone 112 is located proximate the tip 110 of the blade 100, as the streamlines across the blade tend to extend generally radially inward here.

FIG. 3C shows an alternative blade 400 having a roughness zone 412. In this example, the roughened areas 414 and the smooth areas 416 are formed at an angle to the air flow direction F. This angle could be up to around 20°, 15°, 10°, or 5°. In this example, the areas 414, 416 extend slightly radially outward in addition to across the blade 400. Accordingly, it should be understood that, even if they are slightly mis-aligned with the direction across the blade or the air flow direction F, the areas 414, 416 may still be described as extending across the blade if this is their main direction of extent. Outwardly directed roughness areas may be advantageous if the roughness zone 112 is located proximate the root 108 of the blade 100, as the streamlines across the blade tend to extend generally radially outward here.

In some examples, the roughness zone may comprise a mixture of differently angled roughness areas which are substantially aligned to the flow streamlines across the blade at the particular radial location along the blade. A single roughness zone may comprise a plurality of differently extending roughness areas which may be inwardly or outwardly extending, and which may or may not be parallel to one another.

FIG. 3D shows a further alternative blade 500 having a roughness zone 512. In this example, the roughened areas 514 and the smooth areas 516 are formed having a zig-zag shape which is substantially aligned with the air flow direction F across the blade. The zig-zag form may provide the advantage that additional vorticity may be created, which may be beneficial in highly three-dimensional flow separations.

This example illustrates that non-linear areas may still be described as extending across the blade. Although no particular point of the areas 514, 516 extends across the blade 500, it should be understood that the general direction of extent of the areas taken as a whole is substantially aligned across the blade 500 with the air flow direction F. In other examples, the roughened and smooth areas of the roughness zone 512 may be arcuate, curved, or sinusoidal-shaped across the blade 500.

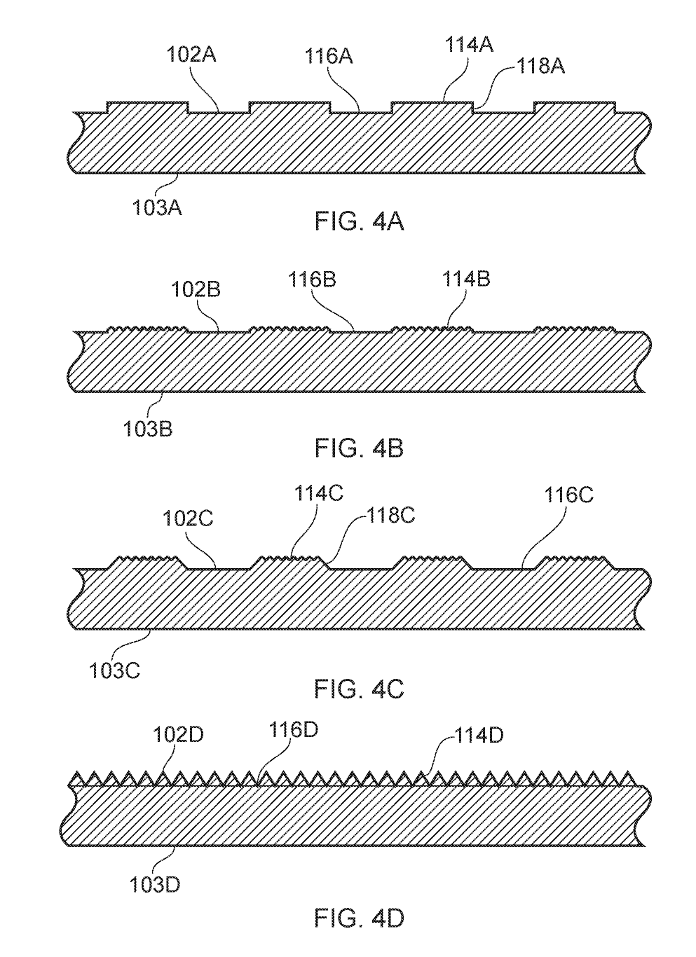

With reference to FIG. 2, the FIGS. 4A-4D show alternative arrangements of the roughness zone 112 of blade 100 taken along the section line S shown in FIG. 2 looking towards the trailing edge of the blade 100. It will be understood that FIGS. 4A-4D illustrate the cross sectional shape of the roughness zone, and these shapes may be combined with any of the shapes of areas discussed in relation to FIGS. 3A-3D.

Turning first to FIG. 4A, the roughness zone 112 is comprised of a plurality of raised areas 114A and grooves 116A. In this example, the raised areas 114A are equivalent to the roughened areas 114 described in relation to FIG. 2, and the grooves 116A are equivalent to the smooth areas 116 described in relation to FIG. 2.

It can be seen that the grooves 116A are formed by step changes 118A in the height of the suction surface 102A. Of course, instead of steps, smooth, curved, or angled transitions may be formed. In some examples, the raised areas 114A may even overhang the grooves 116A for form grooves having a dovetail-like cross-section. Each groove 116A is milled out after the formation of the blade to leave the original suction surface to form the raised areas 114A.

It will be understood that although the upper surfaces of the raised areas 114A may not be rougher than the surface of the grooves 116A, the raised areas 114A may be equivalent to the roughened areas 114, as a roughness zone having raised areas 114A and grooves 116A provides increased roughness in a direction along the blade as opposed to across the blade. In some examples, the upper surfaces of the raised areas 114A may also be roughened compared to the grooves 116A in order to increase their roughness. In some examples, the raised areas 114A may be created by surface deposition of material, such as metal, so they may be naturally rougher than the grooves 116A.

An alternative configuration of the roughened area 112 is shown in FIG. 4B. This configuration is representative of the example discussed above in relation to FIG. 2. Roughness areas 114B are formed having smooth areas 116B therebetween. In order to form the smooth areas 116B, strips of the roughness zone 112 are polished in order to reduce their roughness, while the roughened areas 114A are not polished, such that their surface roughness is much greater than the smooth areas 116A. Accordingly, it will be understood that the roughened areas do not need to be actively roughened by a process; instead, the smooth areas could be simply made less rough compared to the natural state of the roughened areas. Such an example may be particularly easy to manufacture, or could be retro-fitted to existing blades.

In other examples, the entire suction surface 102B could be polished, and then the roughness increased in strips to form the roughened areas 114B in the roughness zone. The roughened areas 114B could be machined or processed to provide increased roughness. The roughened areas 114B could comprise micro holes, which could be formed perpendicular to the suction surface 102B, or at an angle thereto in the manner to form a scale-like finish. In other non-exhaustive examples, the roughened areas 114B could be formed with ball-peening, micro grooves, grinding, sand or metal blasting, brushing, or chemical etching, such as acid etching. Furthermore, the roughened areas 114B could be formed with a roughened coating or roughened element which is applied to the blade. The coating could be a powder, gel, or liquid coating which is applied to the blade to increase surface roughness, or could be a separate roughened layer or element which is affixed to the blade, for example by adhesives or welding. Such examples may be particularly easy to manufacture, or could be retro-fitted to existing blades.

In FIG. 4C, a further configuration of a roughness zone 112 is provided. This example forms a hybrid of the examples of FIGS. 4A and 4B. In this example, grooves 116C are formed to leave raised areas 114C in the manner of FIG. 4A. The grooves 116C may be rough or polished. The raised areas 114C are then either left unpolished, or otherwise have their surface roughness increased in the same manner as the roughness zones 114B of FIG. 4B. In this example, the transitions 118C are angled such that the raised areas 114C are trapezoidal in cross-section. Of course, the transitions 118C could be formed as step changes, or any of the other examples described in relation to the steps 118A of FIG. 4A. The transitions 118C could either be rough or polished.

A further arrangement of a roughness zone is shown in FIG. 4D. In this example, rather than raised areas or roughness areas, the entire zone 112 is formed with a sawtooth-like cross section. A plurality of triangular rails 114D are formed, for example by milling or other machining processes, leaving a plurality of triangular troughs 116D therebetween. Such an arrangement may be particularly easy to manufacture, or may be particularly resistant to flow in a direction along the blade (i.e. across the rails and troughs 114D, 116D).

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A blade or vane for a gas turbine engine comprising a pressure surface and a suction surface, wherein at least one of the pressure surface and the suction surface comprises a roughness zone which is configured to provide greater flow resistance in a direction (y) along the blade or vane than in a direction (x) across the blade or vane.

2. A blade or vane for a gas turbine engine as claimed in claim 1, wherein the roughness zone is elongate and extends generally along the blade or vane.

3. A blade or vane for a gas turbine engine as claimed in claim 1, wherein the roughness zone comprises a plurality of elongate roughened areas which are spaced apart in a direction along the blade or vane and extend generally in a flow direction across the blade or vane.

4. A blade or vane for a gas turbine engine as claimed in claim 3, wherein the roughened areas are substantially continuous along their length.

5. A blade or vane for a gas turbine engine as claimed in claim 3, wherein a plurality of smooth areas are formed between the roughened areas, wherein the smooth areas generally extend in the flow direction across the blade or vane, wherein optionally the smooth areas are polished areas and the roughened areas are unpolished areas.

6. A blade or vane for a gas turbine engine as claimed in claim 3, wherein:
the roughened areas are areas which have been machined or processed to provide increased roughness compared to a remainder of the suction or pressure surface; or
the roughened areas comprise a roughened coating or roughened element which is applied to the blade or vane.

7. A blade or vane for a gas turbine engine as claimed in claim 1, wherein the roughness zone comprises a plurality of grooves are spaced apart in a direction along the blade or vane and extend generally in a flow direction across the blade or vane, and wherein, optionally, a plurality of raised areas are formed between the grooves, wherein the raised areas generally extend in the flow direction across the blade or vane, roughened areas optionally being formed on the raised areas.

8. A blade or vane for a gas turbine engine as claimed in claim 3, wherein the roughened areas are substantially aligned with the flow streamlines across the blade or vane.

9. A blade or vane for a gas turbine engine as claimed in claim 7, wherein the grooves are substantially aligned with the flow streamlines across the blade or vane.

10. A blade or vane for a gas turbine engine as claimed in claim 3, wherein:
the roughened areas are substantially linear and are arranged in parallel; or
the roughened areas are arcuate across the suction surface of the blade; or
the roughened areas are substantially zig-zag shaped.

11. A blade or vane for a gas turbine engine as claimed in claim 7, wherein:
the grooves are substantially linear and are arranged in parallel; or
the grooves are arcuate across the suction surface of the blade; or
the grooves are substantially zig-zag shaped.

12. A blade or vane for a gas turbine engine as claimed in claim 1, wherein:
the roughness zone is formed proximate a leading edge of the blade or vane; or the roughness zone is formed within the foremost 10% of the chord of the blade or vane; or
the roughness zone extends from approximately 20% of the blade or vane height from a root of the blade to approximately 80% of the blade or vane height from the root of the blade or vane; or
the roughness zone is arranged to resist or impede spanwise flow along the blade or vane in use.

13. A blade or vane for a gas turbine engine as claimed in claim 1, wherein the roughness zone is a flutter control feature.

14. A blade or vane as claimed in claim 1, wherein the roughness zone is provided on the suction surface.

15. A blade or vane as claimed in claim 1, wherein the roughness zone is provided on the pressure surface.

16. A blade for a gas turbine engine as claimed in claim 1, wherein the blade is a fan blade for a fan of a gas turbine engine.

17. A fan or bladed disk for a gas turbine engine comprising one or more blades or vanes according to claim 1.

18. A gas turbine engine comprising a fan or bladed disk according to claim 17.

19. A method of manufacturing a blade or vane for a gas turbine engine according to claim 1.

20. A method of modifying a blade or vane for a gas turbine engine comprising forming a roughness zone on a suction surface or pressure surface of the blade or vane, the roughness zone being configured to provide greater flow resistance in a direction (y) along the blade than in a direction (x) across the blade or vane.
